(19) United States
(12) Patent Application Publication
(10) Pub. No.: US 2026/0171022 A1
(43) Pub. Date: Jun. 18, 2026

(54) DISPLAY APPARATUS AND DRIVING METHOD THEREOF

(71) Applicant: LG Display Co., Ltd., Seoul (KR)

(72) Inventor: Jin Ha HONG, Paju-si (KR)

(73) Assignee: LG Display Co., Ltd., Seoul (KR)

(21) Appl. No.: 19/376,670

(22) Filed: Oct. 31, 2025

(30) Foreign Application Priority Data
Dec. 18, 2024 (KR) 10-2024-0189466

(51) Int. Cl. G09G 3/3233

(52) U.S. Cl. CPC G09G 3/3233; G09G 2300/0426; G09G 2300/0819; G09G 2300/0842; G09G 2300/0861; G09G 2310/08; G09G 2320/0233; G09G 2340/0435

(57) ABSTRACT

A display apparatus and a driving method thereof are discussed. The display apparatus can include a display panel having a subpixel, a scan driver configured to apply at least one scan signal to the display panel, a data driver configured to apply a data voltage to the display panel, an initialization voltage line connected to the subpixel, and a control transistor configured to control whether to apply an initialization voltage through the initialization voltage line.

### CROSS-REFERENCE TO RELATED APPLICATIONS

This application claims priority to Korean Patent Application No. 10-2024-0189466 filed in the Republic of Korea on December 18, 2024, which is hereby incorporated by reference as if fully set forth herein in its entirety.

### BACKGROUND

### FIELD OF THE INVENTION

The present disclosure relates to a display apparatus and a driving method thereof.

### Discussion of the Related Art

As information technology advances, the market for display apparatuses which are used as connection mediums for connecting users with information is growing. Therefore, the use of display apparatuses such as light emitting display apparatuses, quantum dot display (QDD) apparatuses, and liquid crystal display (LCD) apparatuses is increasing.

The display apparatuses described above include a display panel having a plurality of subpixels, a driver which outputs a driving signal for driving the display panel, and a power supply which generates power to be supplied to the display panel or the driver.

In such display apparatuses, when the driving signal (for example, a scan signal and a data signal) is supplied to each of the subpixels provided in the display panel, a selected subpixel can transmit light or can self-emit light and thus, an image can be displayed.

### SUMMARY OF THE DISCLOSURE

The present disclosure provides a display apparatus which can block or minimize a coupling effect between an initialization voltage applied through an anode electrode of a light emitting device and a scan signal applied adjacent thereto to prevent the occurrence of a voltage ripple and can stably apply the initialization voltage.

Further, the present disclosure provides a display apparatus which can allow the initialization voltage to be stably applied and can thus prevent or minimize the occurrence of horizontal mura (an image quality defect of a horizontal line), thereby enhancing display quality.

To achieve these objects and other advantages and in accordance with the purpose of the disclosure, as embodied and broadly described herein, a display apparatus includes a display panel including a subpixel, a scan driver configured to apply at least one scan signal to the display panel, a data driver configured to apply a data voltage to the display panel, an initialization voltage line connected to the subpixel, and a control transistor configured to control whether to apply an initialization voltage through the initialization voltage line.

According to aspects of the present disclosure, when at least one scan signal is applied as a voltage for turning on a transistor, the control transistor can be turned off to cut off supply of the initialization voltage.

According to aspects of the present disclosure, the initialization voltage line can include a region disposed to overlap at least one scan signal line.

According to aspects of the present disclosure, the control transistor can be disposed in a non-display area, which does not display an image, of the display panel.

According to aspects of the present disclosure, the subpixel can include a p-type transistor and an n-type transistor, at least one scan line can include an A^{th} scan line controlling the p-type transistor and a B^{th} scan line controlling the n-type transistor, and the control transistor can be turned on or off based on the B^{th} scan signal applied through the B^{th} scan line.

According to aspects of the present disclosure, the subpixel can include first to seventh transistors, at least one scan line can include a first scan line controlling the first transistor, a second scan line controlling the second transistor, a third scan line controlling the sixth transistor and the seventh transistor, and a fourth scan line controlling the fifth transistor, and the control transistor can be turned on or off based on a third scan signal applied through the third scan line.

According to aspects of the present disclosure, the initialization voltage line can include a region disposed to overlap the fourth scan line.

According to aspects of the present disclosure, when a fourth scan signal of a gate high voltage is applied through the fourth scan line, the control transistor can be turned off to cut off supply of the initialization voltage.

In another aspect of the present disclosure, a driving method of a display apparatus include a step of applying a scan signal through at least one scan line connected to the display panel, a step of applying a data voltage through a data line connected to the display panel, and a step of applying an initialization voltage through an initialization voltage line connected to the subpixel, wherein the step of applying the initialization voltage can include cutting off supply of the initialization voltage when the scan signal is applied as a voltage for turning on a transistor included in the display panel.

According to aspects of the present disclosure, the initialization voltage line can include a region disposed to overlap at least one scan signal line.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a display apparatus according to one or more embodiments of the present disclosure, and FIG. 2 is a block diagram illustrating a configuration of a gate driver in the display apparatus of FIG. 1;

FIG. 3 is a cross-sectional view illustrating a stack structure of a display panel according to one or more embodiments of the present disclosure;

FIG. 4 is an example diagram illustrating a control transistor controlling an output of a second initialization voltage and a portion of an element included in a subpixel according to a first embodiment of the present disclosure, FIG. 5 is an example arrangement diagram of the control transistor illustrated in FIG. 4, FIG. 6 is a diagram for describing a comparative example including no control transistor, and FIG. 7 is a diagram for describing the first embodiment including a control transistor;

FIG. 8 is an example diagram illustrating a control transistor controlling an output of an anode initialization voltage and an element included in a subpixel according to a second embodiment of the present disclosure, FIGS. 9 and 10 are example driving waveform diagrams of a display panel implemented based on the subpixel of FIG. 8, and FIG. 11 is a diagram for describing a driving characteristic of the display panel implemented based on the subpixel of FIG. 8;

FIG. 12 is a diagram illustrating a portion of a subpixel implemented based on FIG. 8, FIG. 13 is a diagram for describing a comparative example including no control transistor, and FIG. 14 is a diagram for describing the second embodiment including a control transistor;

FIG. 15 is a diagram for describing a problem occurring when a second initialization voltage increases, in a comparative example including no control transistor, FIG. 16 is a diagram for describing the comparative example including no control transistor, and FIG. 17 is a diagram for describing the second embodiment including a control transistor;

FIG. 18 is an example diagram illustrating a control transistor controlling an output of an anode initialization voltage and an element included in a subpixel according to a third embodiment of the present disclosure, and FIGS. 19 and 20 are example driving waveform diagrams of a display panel implemented based on the subpixel of FIG. 18; and

FIG. 21 is an example diagram illustrating a control transistor controlling an output of an anode initialization voltage and an element included in a subpixel according to a fourth embodiment of the present disclosure, and FIGS. 22 and 23 are example driving waveform diagrams of a display panel implemented based on the subpixel of FIG. 21.

### DETAILED DESCRIPTION OF THE EMBODIMENTS

Hereinafter, various examples of the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

The shapes, dimensions, areas, ratios, angles, numbers, and the like, which are illustrated in the drawings to describe various example embodiments of the present disclosure, are merely given by way of example. Therefore, the present disclosure is not limited to the illustrations in the drawings. Like reference numerals generally denote like elements throughout the specification, unless otherwise specified.

In describing the elements of the present disclosure, terms such as “first,” “second,” “A,” “B,” “(a),” “(b),” or the like can be used. These terms are intended to identify the corresponding element(s) from other element(s), and are not used to define the essence, basis, order, sequence or number of the elements.

Features of various embodiments of the present disclosure can be partially or entirely coupled to or combined with each other and can be operated, linked, or driven together in various ways. Embodiments of the present disclosure can be carried out independently from each other, or can be carried out together in co-dependent or related relationship. Further, the term “can” fully encompasses all the meanings and coverages of the term “may” and vice versa.

All the components of each display device/apparatus according to all embodiments of the present disclosure are operatively coupled and configured.

A display apparatus according to aspects of the present disclosure can be implemented as a light emitting display apparatus or a quantum dot display (QDD) apparatus. Hereinafter, for convenience of description, a light emitting display apparatus self-emitting light based on an inorganic light emitting diode or an organic light emitting diode will be described for example.

Moreover, a thin film transistor (TFT) described below can be implemented with an n-type TFT, a p-type TFT, or a combination of an n-type TFT and a p-type TFT. A TFT can be a three-electrode element including a gate, a source, and a drain. The source can be an electrode which provides a carrier to a transistor. In the TFT, a carrier can start to flow from the source. The drain can be an electrode where the carrier flows from the TFT to the outside. For example, in the TFT, the carrier flows from the source to the drain.

In the p-type TFT, because a carrier is a hole, a source voltage can be higher than a drain voltage so that the hole flows from the source to the drain. In the p-type TFT, because the hole flows from the source to the drain, a current can flow from the source to the drain. On the other hand, in the n-type TFT, because a carrier is an electron, a source voltage can be lower than a drain voltage so that the electron flows from the source to the drain. In the n-type TFT, because the electron flows from the source to the drain, a current can flow from the drain to the source. However, a source and a drain of a TFT can switch therebetween based on a voltage applied thereto. Based thereon, in the following description, one of a source and a drain will be described as a first electrode, and the other of the source and the drain will be described as a second electrode.

Now, various examples and aspects of the present disclosure will be described referring to the drawings.

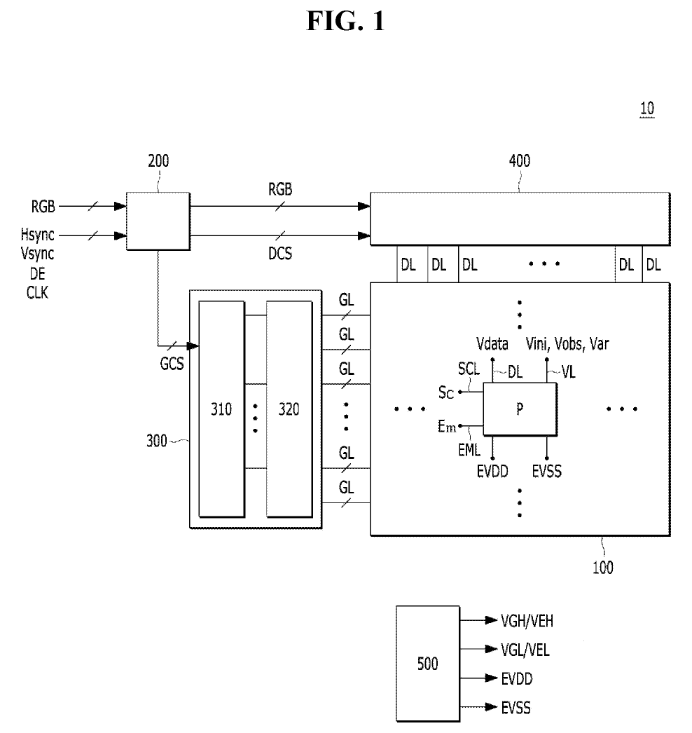

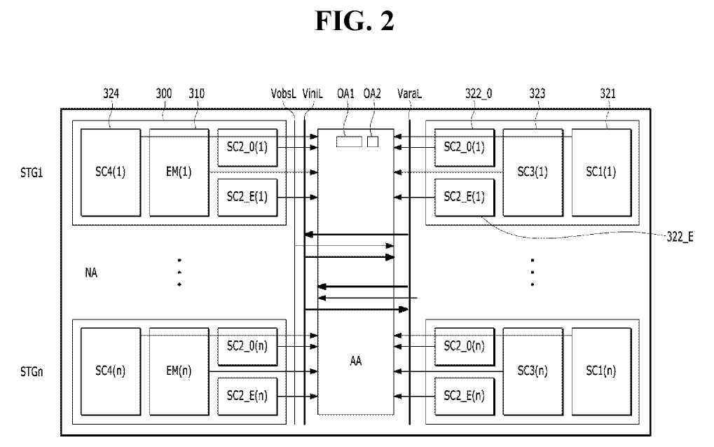

FIG. 1 is a block diagram schematically illustrating a display apparatus 10 according to one or more embodiments of the present disclosure, and FIG. 2 is a block diagram illustrating a configuration of a gate driver in the display apparatus 10.

As illustrated in FIG. 1, the display apparatus 10 can include a display panel 100 which includes a plurality of subpixels SP, a controller 200, a gate driver 300 which supplies a plurality of gate signals to the plurality of subpixels SP, a data driver 400 which supplies a plurality of data signals (or data voltages) to the plurality of subpixels SP, and a power supply 500 which supplies power to the plurality of subpixels SP.

The display panel 100 can include an active area or a display area (see AA of FIG. 2) where the plurality of subpixels P are provided and a non-active area or a non-display area (see NA of FIG. 2) which is disposed to surround the display area AA and where the gate driver 300 and the data driver 400 are disposed. The non-display area NA can surround the display area AA entirely or only in part(s).

In the display panel 100, a plurality of gate lines GL and a plurality of data lines DL can intersect one another, and each of the plurality of subpixels P can be connected to a gate line GL and a data line DL. In detail, one subpixel P can be supplied with a gate signal from the gate driver 300 through the gate line GL, can be supplied with a data voltage (a data signal) from the data driver 400 through the data line DL, and can be supplied with a high-level voltage EVDD and a low-level voltage EVSS from the power supply 500.

The gate line GL can transfer a scan signal Sc and an emission control signal Em to the plurality of subpixels SP, and the data line DL can transfer a data voltage Vdata to the plurality of subpixels SP. According to various embodiments, the gate line GL can include a plurality of scan lines SCL for supplying the scan signal Sc and a plurality of emission control lines EML for supplying the emission control signal Em. The plurality of subpixels P can be supplied with voltages Vini, Var, and Vobs through a plurality of voltage lines VL. The voltages Vini, Var, and Vobs applied through the plurality of voltage lines VL will be described below.

Each of the plurality of subpixels P can include a subpixel driving circuit. The subpixel driving circuit can include a plurality of switching elements, a driving element, and a capacitor. The switching element and the driving element can each be configured as a TFT. A switching transistor can be turned on based on the scan signal Sc supplied through the scan line SCL and the emission control signal Em supplied through the emission control line EML. A driving transistor can control the amount of current (control the amount of emitted light) supplied to a light emitting device OLED, based on the data voltage Vdata.

The display panel 100 can be implemented as a non-transmissive display panel or a transmissive display panel. The transmissive display panel can be applied to a transparent display apparatus which displays an image on a screen thereof and enables a real thing of a background to be seen. The display panel 100 can be implemented as a flexible display panel. The flexible display panel can use a plastic substrate. Each of the plurality of subpixels P can be divided into a red subpixel, a green subpixel, and a blue subpixel for color implementation. Each of the plurality of subpixels P can further include a white subpixel.

Touch sensors can be disposed in the display panel 100. A touch input can be sensed by using separate touch sensors, or can be sensed through the plurality of subpixels SP. The touch sensors can be arranged as an on-cell type or an add-on type in a screen of the display panel 100, or can be implemented as in-cell type touch sensors embedded in the display panel 100.

The controller 200 can process image data RGB input from the outside to supply to the data driver 400, based on a size and a resolution of the display panel 100. The controller 200 can generate a gate control signal GCS and a data control signal DCS by using synchronization signals (for example, a dot clock signal CLK, a data enable signal DE, a horizontal synchronization signal Hsync, and a vertical synchronization signal Vsync) input from the outside. The controller 200 can supply the gate control signal GCS to the gate driver 300 to control an operation timing of the gate driver 300. The controller 200 can supply the data control signal DCS to the data driver 400 to control an operation timing of the data driver 400. The controller 200 can synchronize the operation timing of the gate driver 300 with the operation timing of the data driver 400 by using the gate control signal GCS and the data control signal DCS.

The controller 200 can be configured to be coupled to various processors (for example, a microprocessor, a mobile processor, and an application processor), based on a device mounted thereon. A host system disposed a previous end with respect to the controller 200 can be one of a television (TV) system, a set-top box, a navigation system, a personal computer (PC), a home theater system, a mobile device, a wearable device, and an automotive system.

The controller 200 can multiply an input frame frequency by i (where i can be a positive integer of more than 0) times to control an operation timing of the display panel driver, based on a frame frequency of an input frame frequency × i Hz. The input frame frequency can be about 60 Hz in national television standards committee (NTSC) scheme and can be about 50 Hz in phase-alternating line (PAL) scheme.

The controller 200 can drive the display panel 100 at various refresh rates. The controller 200 can drive the display panel 100 as a switchable type in a variable refresh rate (VRR) mode, namely, between a first refresh rate and a second refresh rate.

For example, the controller 200 can simply change a speed of a clock signal, or can generate a synchronization signal so that a horizontal blank or a vertical blank occurs, or can drive the gate driver 300 in a mask mode, thereby driving the display panel 100 at various refresh rates. The vertical blank can be defined as a period for allowing an input of a data signal to match a timing at which an image is output (displayed) to (on) the display panel. The vertical blank can be repeated at one frame period and can synchronize, with each other, various signals for an operation of the display apparatus during a corresponding period.

A voltage level of the gate control signal GCS output from the controller 200 can be converted into an on voltage and an off voltage by a level shifter and can be supplied to the gate driver 300. The level shifter can shift a low level voltage of the gate control signal GCS to a gate low voltage VGL and can shift a high level voltage of the gate control signal GCS to a gate high voltage VGH. The gate control signal GCS can include a start pulse and a shift clock.

The gate driver 300 can supply the gate signal to the gate line GL, based on the gate control signal GCS supplied from the controller 200. The gate driver 300 can be disposed at one side or both sides of the display panel 100 in a gate in panel (GIP) type.

The gate driver 300 can sequentially output the gate signal to the plurality of gate lines GL, based on control by the controller 200. The gate driver 300 can shift the gate signal by using a shift register, and thus, can sequentially supply the signals to the gate lines GL.

In an organic light emitting display apparatus, the gate signal can include the scan signal Sc and the emission control signal Em. The scan signal Sc can include a scan pulse which swings between a gate low voltage VGL and a gate high voltage VGH. The emission control signal Em can include an emission control signal pulse which swings between a gate on voltage VEL and a gate off voltage VEH. The scan pulse can select subpixels P of a line in which a data voltage Vdata is to be written. The emission control signal Em can define an emission time of each of the subpixels SP.

The gate driver 300 can include an emission control signal driver 310 and one or more scan drivers 320. The emission control signal driver 310 can output the emission control signal pulse in response to the start pulse and the shift clock from the controller 200 and can sequentially shift the emission control signal pulse according to the shift clock. The one or more scan drivers 320 can output the scan pulse in response to the start pulse and the shift clock from the controller 200 and can shift the scan pulse, based on a shift clock timing.

The data driver 400 can convert the image data RGB into a data voltage Vdata, based on the data control signal DCS supplied from the controller 200, and can output the data voltage Vdata through the data line DL.

In FIG. 1, it is illustrated that the data driver 400 is disposed as one type at one side of the display panel 100, but the number and arrangement positions of data drivers 400 are not limited thereto. For example, the data driver 400 can be configured with a plurality of integrated circuits (ICs) and can be provided in plurality, and the plurality of data drivers 400 can be divisionally arranged at one side of the display panel 100.

The power supply 500 can generate a direct current (DC) power needed for driving of the display panel driver and a subpixel array of the display panel 100 by using a DC-DC converter. The DC-DC converter can include a charge pump, a regulator, a buck converter, and a boost converter. The power supply 500 can receive a DC input voltage applied from the host system to generate DC voltages such as a gate voltage VGL, VEL, VGH, and VEH, the high-level voltage EVDD, and the low-level voltage EVSS.

As illustrated in FIGS. 1 and 2, the gate driver 300 can include the emission control signal driver 310 and the scan driver 320. The scan driver 320 can include first to fourth scan drivers 321 to 324. Further, the second scan driver 322 can include odd-numbered second scan drivers 322_O and even-numbered second scan drivers 322_E.

Shift registers configuring the gate driver 300 can be configured to be symmetric at both sides of the display area AA. The shift register of one side of the display area AA can include second scan drivers 322_O and 322_E, the fourth scan driver 324, and the emission control signal driver 310, and the shift register of the other side of the display area AA can include the first scan driver 321, second scan drivers 322_O and 322_E, and the third scan driver 323. In FIG. 2, an example is illustrated where the odd-numbered second scan driver 322_O and the even-numbered second scan driver 322_E have a structure where an odd-numbered subpixel and an even-numbered subpixel share the second scan driver 322. Accordingly, the emission control signal driver 310 and the first to fourth scan drivers 321 to 324 can be differently arranged, but are not limited thereto.

Stages STG1 to STGn of the shift register can respectively include first scan signal generators SC1(1) to SC1(n), second scan signal generators SC2_O(1) to SC2_O(n) and SC2_E(1) to SC2_E(n), third scan signal generators SC3(1) to SC3(n), fourth scan signal generators SC4(1) to SC4(n), and emission control signal generators EM(1) to EM(n). Here, n can be a real number such as an integer greater than 1.

The first scan signal generators SC1(1) to SC1(n) can respectively output first scan signals through first scan lines SCL1 of the display panel 100. The second scan signal generators SC2(1) to SC2(n) can respectively output second scan signals through second scan lines SCL2 of the display panel 100. The third scan signal generators SC3(1) to SC3(n) can respectively output third scan signals through third scan lines SCL3 of the display panel 100. The fourth scan signal generators SC4(1) to SC4(n) can respectively output fourth scan signals through fourth scan lines SCL4 of the display panel 100. The emission control signal generators EM(1) to EM(n) can respectively output emission control signals through emission control lines EML of the display panel 100.

The first scan signals can be used as a signal for driving an A^{th} transistor (for example, a compensation transistor) included in the subpixel driving circuit. The second scan signals can be used as a signal for driving a B^{th} transistor (for example, a data supply transistor) included in the subpixel driving circuit. The third scan signals can be used as a signal for driving a C^{th} transistor (for example, a bias transistor) included in the subpixel driving circuit. The fourth scan signals can be used as a signal for driving a D^{th} transistor (for example, an initialization transistor) included in the subpixel driving circuit. The emission control signals can be used as a signal for driving an E^{th} transistor (for example, an emission control transistor) included in the subpixel driving circuit. For example, when the emission control transistor is controlled by using the emission control signals, an emission time of a light emitting device can vary.

A bias voltage line VobsL transferring a bias voltage, a first initialization voltage line ViniL transferring a first initialization voltage Vini, and a second initialization voltage line VaraL transferring a second initialization voltage Var can be disposed between the gate driver 300 and the display area AA.

In the drawing, each of the bias voltage line VobsL, the first initialization voltage line ViniL, and the second initialization voltage line VaraL is illustrated as being disposed at one side of a left side or a right side of the display area AA, but is not limited thereto and can be disposed at both sides, or even when being disposed at one side, a position is not limited to the left side or the right side.

Furthermore, one or more optical regions OA1 and OA2 can be disposed in the display area AA. The optical regions OA1 and OA2 can be disposed to overlap one or more optical electronic devices such as an imaging device such as a camera (an image sensor) and a sensing sensor such as a proximity sensor and an illumination sensor.

The optical regions OA1 and OA2 can have a light transmissive structure, for an operation of an optical electronic device, and thus, can have a transmittance of a certain level or more. In other words, the number of pixels P per unit area in the optical regions OA1 and OA2 can be less than the number of pixels per unit area in a normal region, except the optical regions OA1 and OA2, of the display area AA. For example, a resolution of each of the optical regions OA1 and OA2 can be lower than that of the normal region of the display area AA.

In the optical regions OA1 and OA2, the light transmissive structure can be configured by patterning a cathode electrode in a portion where a subpixel is not disposed. In this case, the patterned cathode electrode can be removed by using a laser, or by using a material such as a cathode deposition prevention layer, the cathode electrode can be selectively patterned.

Moreover, in the optical regions OA1 and OA2, the light transmissive structure can be configured by separately forming a light emitting device and a subpixel driving circuit included in a subpixel. In other words, the light emitting device of the subpixel can be disposed in the optical regions OA1 and OA2, and a plurality of transistors configuring the subpixel driving circuit can be disposed near the optical regions OA1 and OA2, and thus, the light emitting device can be electrically connected to the subpixel driving circuit through a transparent metal layer.

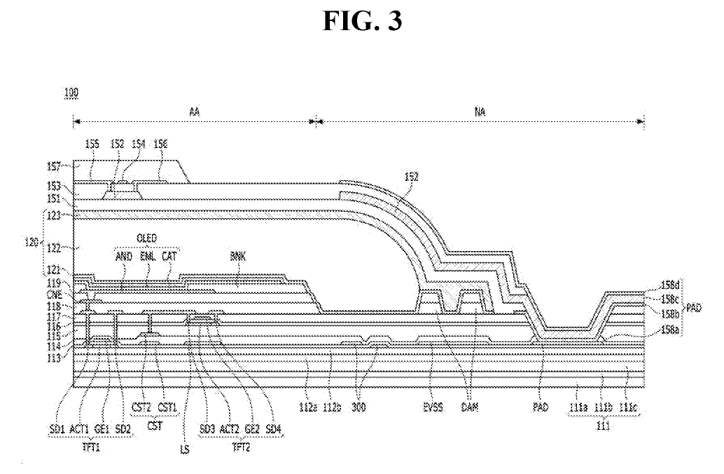

FIG. 3 is a cross-sectional view illustrating a stack structure of the display panel 100 according to an embodiment of the present disclosure.

As illustrated in FIG. 3, transistors TFT1 and TFT2 and a capacitor CST for driving a light emitting device OLED disposed in a display area AA can be disposed on a substrate 111 of the display panel 100. The transistors TFT1 and TFT2 can include: a switching/driving thin film transistor including a polycrystalline semiconductor material, and an oxide thin film transistor including an oxide semiconductor material. In this case, a thin film transistor including a polycrystalline semiconductor material can be referred to as a polycrystalline thin film transistor TFT1, and a thin film transistor including an oxide semiconductor material can be referred to as an oxide thin film transistor TFT2. For example, the polycrystalline thin film transistor TFT1 can be a transistor connected to the light emitting device OLED, and the oxide thin film transistor TFT2 can be a transistor connected to the capacitor CST.

The substrate 111 can include a first substrate layer 111a, a second substrate layer 111b, and a third substrate layer 111c. The first substrate layer 111a and the third substrate layer 111c can be selected as an organic layer including polyimide, and the second substrate layer 111b disposed between the first substrate layer 111a and the third substrate layer 111c can be selected as an inorganic layer such as oxide silicone (SiO₂).

A lower buffer layer 112a can be formed on the substrate 111. The lower buffer layer 112a can be for preventing the penetration of water from the outside and can use an SiO₂ layer which is stacked as a multilayer. An auxiliary buffer layer 112b can be further disposed on the lower buffer layer 112a, so as to protect elements from the penetration of water.

The polycrystalline thin film transistor TFT1 can be formed on the substrate 111. The polycrystalline thin film transistor TFT1 can use a polycrystalline semiconductor as an active layer. The polycrystalline thin film transistor TFT1 can include a first active layer ACT1 including a channel through which an electron or a hole moves, a first gate electrode GE1, a first source electrode SD1, and a first drain electrode SD2. A first gate insulation layer 113 can be disposed between the first gate electrode GE1 and the first active layer ACT1 and can use an inorganic layer such as nitride silicone (SiNx) or a SiO₂ layer, which is stacked as a single layer or a multiplayer.

The first active layer ACT1 can include a first channel region, a first source region disposed at one side with respect to the first channel region, and a first drain region disposed at the other side with respect to the first channel region. The first source region and the first drain region can each be a region which is conductive by doping a Group V or III impurity ion (for example, phosphorus (P) or boron (B)) on an intrinsic polycrystalline semiconductor material at a certain concentration. The first channel region can allow a polycrystalline semiconductor material to maintain an intrinsic state and can provide a path through which an electron or a hole moves.

According to an embodiment of the present disclosure, the polycrystalline thin film transistor TFT1 can be implemented in a top gate structure where the first gate electrode GE1 is disposed on the first active layer ACT1. Accordingly, a first electrode CST1 included in the capacitor CST and a light blocking layer LS included in the oxide thin film transistor TFT2 can be formed of the same material as that of the first gate electrode GE1. The first gate electrode GE1, the first electrode CST1, and the light blocking layer LS can be formed through one mask process, thereby reducing the number of mask processes.

The first gate electrode GE1 can include a metal material. For example, the first gate electrode GE1 can be a single layer or a multilayer including one of molybdenum (Mo), aluminum (Al), chrome (Cr), gold (Au), titanium (Ti), nickel (Ni), neodymium (Nd), and copper (Cu), or an alloy thereof, but is not limited thereto. A first interlayer insulation layer 114 can be disposed on the first gate electrode GE1. The first interlayer insulation layer 114 can be implemented with SiO₂ or SiNx.

The display panel 100 can further include an upper buffer layer 115, a second gate insulation layer 116, and a second interlayer insulation layer 117, which are sequentially disposed on the first interlayer insulation layer 114, and the polycrystalline thin film transistor TFT1 can include a first source electrode SD1 and a first drain electrode SD2, which are formed on the second interlayer insulation layer 117 and are respectively connected to the first source region and the first drain region.

The first source electrode SD1 and the first drain electrode SD2 can be a single layer or a multilayer including one of Mo, Al, Cr, Au, Ti, Ni, Nd, and Cu, or an alloy thereof, but are not limited thereto.

The upper buffer layer 115 can separate the second active layer ACT2 of the oxide thin film transistor TFT2, implemented with an oxide semiconductor material, from the first active layer ACT1 implemented with a polycrystalline semiconductor material and can provide a basis for forming the second active layer ACT2.

The second gate insulation layer 116 can cover the second active layer ACT2 of the oxide thin film transistor TFT2. The second gate insulation layer 116 can be formed on the second active layer ACT2 implemented with an oxide semiconductor material, and thus, can be implemented as an inorganic layer. For example, the second interlayer insulation layer 116 can be SiO₂ or SiNx.

The second gate electrode GE2 can be configured with a metal material. For example, the second gate electrode GE2 can be a single layer or a multilayer including one of Mo, Al, Cr, Au, Ti, Ni, Nd, and Cu, or an alloy thereof, but is not limited thereto.

The oxide thin film transistor TFT2 can be formed on the upper buffer layer 115. The oxide thin film transistor TFT2 can include a second active layer ACT2 implemented with an oxide semiconductor material, a second gate electrode GE2 disposed on the second gate insulation layer 116, and a second source electrode SD3 and a second drain electrode SD4 which are disposed on the second interlayer insulation layer 117. The second active layer ACT2 can be implemented with an oxide semiconductor material and can include an intrinsic second channel region which is not doped with impurities and a second source region and a second drain region which are conductive by doping impurities.

The oxide thin film transistor TFT2 can further include a light blocking layer LS which is disposed under the upper buffer layer 115 to overlap the second active layer ACT2. The light blocking layer LS can prevent light from being incident on the second active layer ACT2 and can thus secure the reliability of the oxide thin film transistor TFT2. The light blocking layer LS can be formed of the same material as that of the first gate electrode GE1 and can be disposed on an upper surface of the first gate insulation layer 113. The light blocking layer LS can be electrically connected to the second gate electrode GE2 to configure a dual gate.

The second source electrode SD3 and the second drain electrode SD4 can be simultaneously formed of the same material on the second interlayer insulation layer 117 along with the first source electrode SD1 and the first drain electrode SD2, and thus, the number of mask processes can be reduced.

Furthermore, the second electrode CST2 can be disposed on the first interlayer insulation layer 114 to overlap the first electrode CST1 and can thus implement the capacitor CST. For example, the second electrode CST2 can be a single layer or a multilayer including one of Mo, Al, Cr, Au, Ti, Ni, Nd, and Cu, or an alloy thereof.

The capacitor CST can store a data voltage, applied through a data line DL, during a certain period. The capacitor CST can include two electrodes corresponding to each other and a dielectric disposed therebetween. The first interlayer insulation layer 114 can be disposed between the first electrode CST1 and the second electrode CST2.

The first electrode CST1 or the second electrode CST2 of the capacitor CST can be electrically connected to the second source electrode SD3 or the second drain electrode SD4 of the oxide thin film transistor TFT2. However, an embodiment of the present disclosure is not limited thereto, and a connection relationship of the capacitor CST can be changed based on a subpixel driving circuit.

A first planarization layer 118 and a second planarization layer 119 for planarizing a surface can be sequentially disposed on the subpixel driving circuit. The first planarization layer 118 and the second planarization layer 119 can each be an organic layer such as polyimide or acrylic resin. The light emitting device OLED can be formed on the second planarization layer 119.

The light emitting device OLED can include an anode electrode AND, a cathode electrode CAT, and an emission layer EML disposed between the anode electrode AND and the cathode electrode CAT. In a case where the subpixel driving circuit using in common a low-level voltage connected to the cathode electrode CAT is implemented, the anode electrode AND can be disposed as a separate electrode for each subpixel. On the other hand, in a case where the subpixel driving circuit using in common a high-level voltage is implemented, the cathode electrode CAT can be disposed as a separate electrode for each subpixel.

The light emitting device OLED can be electrically connected to a driving element through a center electrode CNE disposed on the first planarization layer 118. For example, the anode electrode AND of the light emitting device OLED and the first source electrode SD1 of the polycrystalline thin film transistor TFT1 configuring the subpixel driving circuit can be connected to each other by the center electrode CNE.

The anode electrode AND can be connected to the center electrode CNE exposed through a contact hole passing through the second planarization layer 119. The center electrode CNE can be connected to the first source electrode SD1 exposed through a contact hole passing through the first planarization layer 118.

The center electrode CNE can function as a medium which connects the first source electrode SD1 to the anode electrode AND. The center electrode CNE can include a conductive material such as Cu, Ag, Mo, or Ti.

The anode electrode AND can be formed in a multi-layer structure including a transparent conductive layer and an opaque conductive layer which is high in reflection efficiency. The transparent conductive layer can include a material, which is relatively large in work function value, such as indium tin oxide (ITO) or indium zinc oxide (IZO), and the opaque conductive layer can be formed in a single-layer or multi-layer structure which includes Al, Ag, Cu, lead (Pb), Mo, or Ti, or an alloy thereof. For example, the anode electrode AND can be formed in a structure where a transparent conductive layer, an opaque conductive layer, and a transparent conductive layer are sequentially stacked, or can be formed in a structure where a transparent conductive layer and an opaque conductive layer are sequentially stacked. The emission layer EML can be formed by stacking a hole-related layer, an organic emission layer, and an electron-related layer on the anode electrode AND in order or reverse order.

A bank layer BNK can be a subpixel definition layer which exposes the anode electrode AND of each subpixel. The bank layer BNK can be formed of an opaque material (for example, black) so as to prevent light interference between adjacent subpixels. In this case, the bank layer BNK can include a light blocking material including at least one of a color pigment, organic black, and carbon.

The cathode electrode CAT can be formed on an upper surface and a lateral surface of the emission layer EML so as to be opposite to the anode electrode AND with the emission layer EML therebetween. The cathode electrode CAT can be formed as one body to cover all of the display area AA. In a case where the cathode electrode CAT is applied to an organic light emitting display apparatus of a top emission type, the cathode electrode CAT can include a transparent conductive layer such as ITO or IZO.

An encapsulation layer 120 for preventing the penetration of water can be further disposed on the cathode electrode CAT. The encapsulation layer 120 can prevent the penetration of external water or oxygen into the emission layer EML vulnerable to external water or oxygen. To this end, the encapsulation layer 120 can include an at least one-layer inorganic encapsulation layer and an at least one-layer organic encapsulation layer, but is not limited thereto. The encapsulation layer 120 can include a first encapsulation layer 121, a second encapsulation layer 122, and a third encapsulation layer 123, which are sequentially stacked.

The first encapsulation layer 121 and the third encapsulation layer 123 can include an inorganic insulating material, which is capable of low temperature deposition, such as SiNx, SiOx, silicon oxynitride (SiON), or aluminum oxide (Al₂O₃). The first encapsulation layer 121 and the third encapsulation layer 123 can be deposited in a low temperature atmosphere, and thus, can prevent the damage of the emission layer EML vulnerable to a high temperature atmosphere when performing a deposition process of the first encapsulation layer 121 and the third encapsulation layer 123.

The second encapsulation layer 122 can perform a buffer function of decreasing a stress between layers caused by the bending of the display apparatus 10 and can planarize a step height between layers. The second encapsulation layer 122 can be formed on the substrate 111 where the first encapsulation layer 121 is formed and can include acryl resin, epoxy resin, phenolic resin, polyamide resin, polyimide resin, and polyethylene, or a non-photosensitive organic insulating material such as silicon oxycarbon (SiOC), or a photosensitive organic insulating material such as photo acryl, but an embodiment of the present disclosure is not limited thereto.

In a case where the second encapsulation layer 122 is formed through an inkjet process, a dam DAM can be disposed to prevent the second encapsulation layer 122 from being diffused to an edge of the substrate 111. The dam DAM can be disposed closer to the edge of the substrate 111 than the second encapsulation layer 122. The dam DAM can prevent the second encapsulation layer 122 from being diffused to a pad region where a conductive pad disposed at an outermost portion of the substrate 111 is provided.

The dam DAM can be designed to prevent the diffusion of the second encapsulation layer 122, but in a case where the second encapsulation layer 122 is formed to flow over a height of the dam DAM when performing a process, the second encapsulation layer 122 which is an organic layer can be exposed at the outside, and due to this, water can easily penetrate into the light emitting device OLED. Accordingly, in order to solve such a problem, the dam DAM can be provided as ten or more to overlap each other.

The dam DAM can be disposed on the second interlayer insulation layer 117 of a non-display area NA. Further, the dam DAM can be formed simultaneously with the first planarization layer 118 and the second planarization layer 119. A lower layer of the dam DAM can be formed together when forming the first planarization layer 118, and an upper layer of the dam DAM can be formed together when forming the second planarization layer 119, and thus, the dam DAM can be stacked and formed in a double structure. Accordingly, the dam DAM can include the same insulating material as that of the first planarization layer 118 and the second planarization layer 119, but an embodiment of the present disclosure is not limited thereto.

The dam DAM can be formed to overlap a low-level voltage line EVSS. For example, the low-level voltage line EVSS can be disposed in a lower layer of a region, where the dam DAM is disposed, of the non-display area NA. The low-level voltage line EVSS can be disposed more outward than the gate driver 300 and can surround the display area AA. For example, the low-level voltage line EVSS can include the same material as that of the first gate electrode GE1, but is not limited thereto and can include the same material as that of the second electrode CST2 or the first source electrode SD1 and the first drain electrode SD2. The low-level voltage line EVSS can be electrically connected to the cathode electrode CAT so as to apply the low-level voltage EVSS to a plurality of subpixels included in the display area AA.

A touch layer can be disposed on the encapsulation layer 120. In the touch layer, a touch buffer layer 151 can be disposed between the cathode electrode CAT of the light emitting device OLED and a touch sensor metal layer including touch electrodes 155 and 156 and touch electrode connection lines 152 and 154.

The touch buffer layer 151 can prevent external water or a chemical solution (for example, a developer or an etchant), which is used in a manufacturing process of the touch sensor metal layer disposed on the touch buffer layer 151, from penetrating into the emission layer EML including an organic material. Accordingly, the touch buffer layer 151 can prevent the damage of the emission layer EML vulnerable to the chemical solution or water.

The touch buffer layer 151 can include an organic insulating material which has a low dielectric constant of 1 to 3 and is capable of being formed at a low temperature of a certain temperature (for example, 100 ℃) or less, so as to prevent the damage of the emission layer EML including an organic material vulnerable to a high temperature. For example, the touch buffer layer 151 can include an acrylic material, an epoxy-based material, or a siloxan-based material. The touch buffer layer 151 which includes an organic insulating material and has planarization performance can prevent the damage of the encapsulation layer 120 caused by the bending of an apparatus and the breakage of the touch sensor metal layer formed on the touch buffer layer 151.

According to a touch sensor structure based on a mutual capacitance, the touch electrodes 155 and 156 can be disposed on the touch buffer layer 151, and the touch electrodes 155 and 156 can be disposed to intersect each other. The touch electrode connection lines 152 and 154 can electrically connect the touch electrodes 155 and 156 with each other. The touch electrode connection lines 152 and 154 and the touch electrodes 155 and 156 can be disposed in different layers with the touch insulation layer 153 therebetween. The touch electrode connection lines 152 and 154 can be disposed to overlap the bank layer BNK and can prevent a reduction in aperture ratio.

In the touch electrodes 155 and 156, a portion of the touch electrode connection line 152 can pass through an upper portion and a lateral surface of the encapsulation layer 120 and an upper portion and a lateral surface of the dam DAM and can be electrically connected to a touch driving circuit through a touch pad PAD. A portion of the touch electrode connection line 152 can be supplied with a touch driving signal from a touch driving circuit and can transfer the touch driving signal to the touch electrodes 155 and 156, or can transfer touch sensing signals of the touch electrodes 155 and 156 to the touch driving circuit.

A touch protection layer 157 can be disposed on the touch electrodes 155 and 156. In the drawings, the touch protection layer 157 is illustrated as being disposed on only the touch electrodes 155 and 156, but an embodiment of the present disclosure is not limited thereto and the touch protection layer 157 can extend up to a previous portion or a next portion with respect to the dam DAM and can be disposed on the touch electrode connection line 152. Moreover, a color filter can be further disposed on the encapsulation layer 120, and the color filter can be disposed on the touch layer or can be disposed between the encapsulation layer 120 and the touch layer.

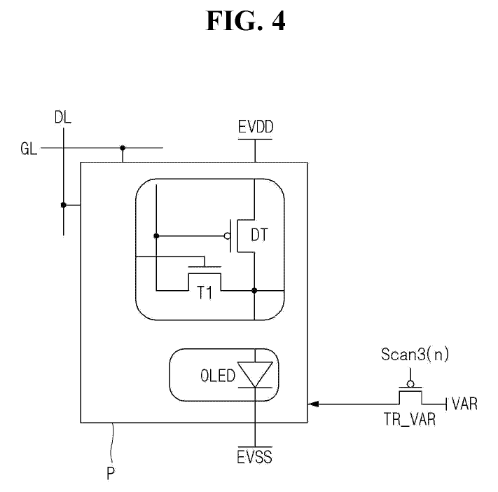

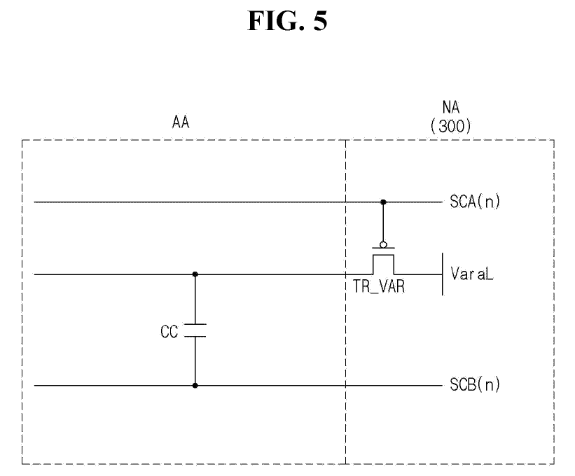

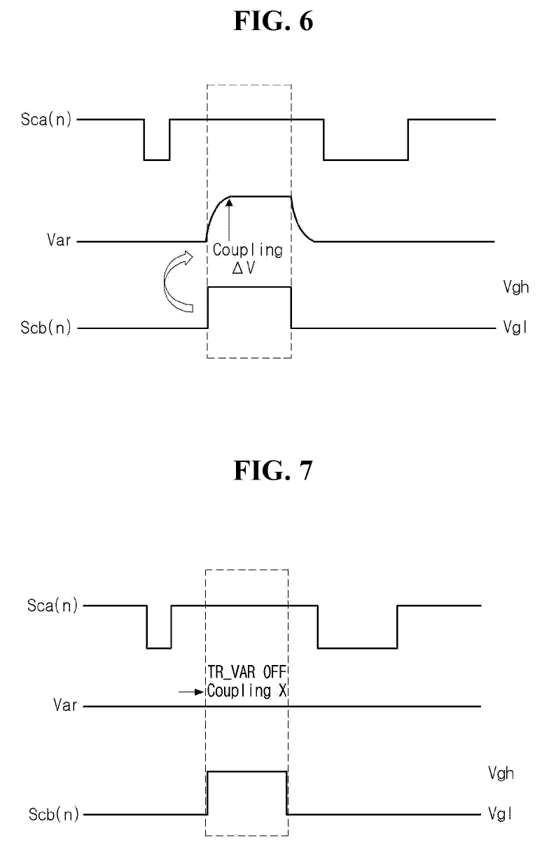

FIG. 4 is an example diagram illustrating a control transistor controlling an output of a second initialization voltage and a portion of an element included in a subpixel of a display apparatus according to a first embodiment of the present disclosure, FIG. 5 is an example arrangement diagram of the control transistor illustrated in FIG. 4, FIG. 6 is a diagram for describing a comparative example including no control transistor, and FIG. 7 is a diagram for describing the first embodiment including the control transistor.

As illustrated in FIG. 4, a subpixel P (e.g., each subpixel P of the display apparatus) can include a driving transistor DT, a first transistor T1, and a light emitting device OLED. The driving transistor DT can be implemented as a p type. The p-type driving transistor DT can operate based on a data voltage applied in the form of low voltage and can generate a driving current which is to be supplied to the light emitting device OLED. The first transistor T1 can be implemented as an n type. The n-type first transistor T1 can operate based on a scan signal applied in the form of high voltage, and the driving transistor DT can be formed in a diode connection state. The light emitting device OLED can emit light according to a driving current generated based on operations of the first transistor T1 and the driving transistor DT.

As described above, the subpixel P can be implemented based on transistors of two types, but is not limited thereto. Further, the subpixel P can further include a circuit for compensating for the driving transistor DT or the light emitting device OLED. Therefore, a circuit included in the subpixel P can be variously implemented and should refer to FIG. 4.

The subpixel P can be connected to a control transistor TR_VAR which controls an output of a second initialization voltage (control whether to apply an initialization voltage). The control transistor TR_VAR can be turned on or off so as to perform control so that a second initialization voltage transferred through a second initialization voltage line VaraL is applied or not applied to the subpixel P. The control transistor TR_VAR is implemented as a p type as an example, but it can also be implemented as an n type.

The control transistor TR_VAR can include a gate electrode connected to an A^{th} scan line SCA(n) to which an A^{th} scan signal is applied, a first electrode connected to the second initialization voltage line VaraL to which the second initialization voltage is applied, and a second electrode connected to the subpixel P. To provide an additional description, the control transistor TR_VAR can include the gate electrode connected to the A^{th} scan line SCA(n), the first electrode connected to a second initialization voltage source, and the second electrode connected to the second initialization voltage line VaraL connected to the subpixel P. To provide an additional description, the control transistor TR_VAR can include the gate electrode connected to the A^{th} scan line SCA(n), the first electrode connected to one side of the second initialization voltage line VaraL, and the second electrode connected to the other side of the second initialization voltage line VaraL. The second initialization voltage output from the control transistor TR_VAR can be applied to an anode electrode of the light emitting device OLED. Further, the second initialization voltage can be defined as an anode initialization voltage for initializing the anode electrode of the light emitting device OLED.

As illustrated in FIGS. 4 and 5, the control transistor TR_VAR can be disposed in a non-display area NA adjacent to the gate driver 300. The A^{th} scan line SCA(n) for controlling the control transistor TR_VAR and a B^{th} scan line SCB(n) for controlling a transistor included in the subpixel P can be disposed in a display area AA and the non-display area NA.

The B^{th} scan line SCB(n) can be disposed adjacent to the second initialization voltage line VaraL transferring the second initialization voltage, or can have an overlapping relationship. In this case, a parasitic capacitor CC can be formed between the second initialization voltage line VaraL and the B^{th} scan line SCB(n).

In a case where the parasitic capacitor CC is formed between the second initialization voltage line VaraL and the B^{th} scan line SCB(n), a second initialization voltage Var can be affected by a B^{th} scan signal Scb(n) transferred through the B^{th} scan line SCB(n).

As illustrated in FIGS. 5 and 6, for example, when the B^{th} scan signal Scb(n) is applied as a gate low voltage Vgl (or a turn-off voltage of a transistor) and is then applied as a gate high voltage Vgh (or a turn-on voltage of a transistor), the second initialization voltage Var can be put in a coupling state affected by the B^{th} scan signal Scb(n) of the gate high voltage Vgh, and thus, can increase (see ΔV of FIG. 6).

As illustrated in FIGS. 5 and 7, for example, when the control transistor TR_VAR is turned off (TR_VAR OFF) while the B^{th} scan signal Scb(n) is applied as the gate low voltage Vgl and is then applied as the gate high voltage Vgh, the second initialization voltage Var can be put in a decoupling state (a state where the supply of the second initialization voltage is cut off) which is not affected by the B^{th} scan signal Scb(n) of the gate high voltage Vgh, and thus, may not increase.

Furthermore, the control transistor TR_VAR can have a turn-off state prior to a time at which the gate high voltage Vgh of the B^{th} scan signal Scb(n) occurs. Further, the control transistor TR_VAR can maintain a turn-off state for a certain time even after the B^{th} scan signal Scb(n) is shifted from the gate high voltage Vgh to the gate low voltage Vgl. Accordingly, a coupling effect between the second initialization voltage Var and the B^{th} scan signal Scb(n) can be completely excluded, and this should be construed as an example.

Therefore, the first embodiment can physically/electrically prevent a coupling problem which increases as an anode initialization voltage for initializing the anode electrode of the light emitting device OLED through the control transistor TR_VAR is affected by an adjacent scan signal. Hereinafter, the first embodiment will be described in more detail based on a circuit configuration of a subpixel and a driving method thereof.

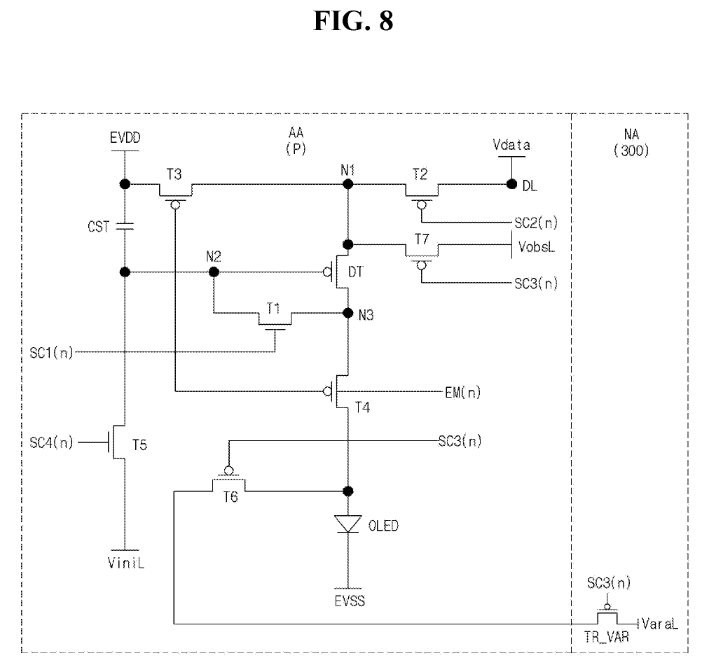

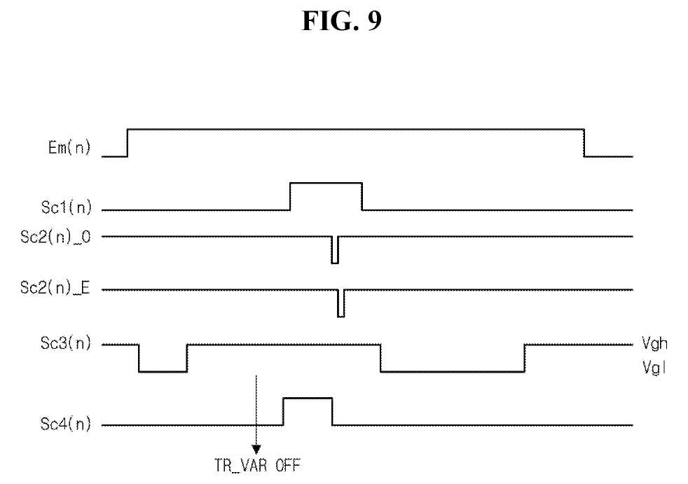

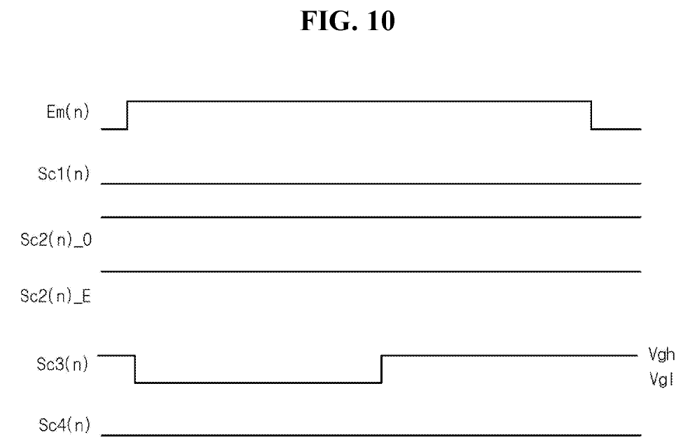

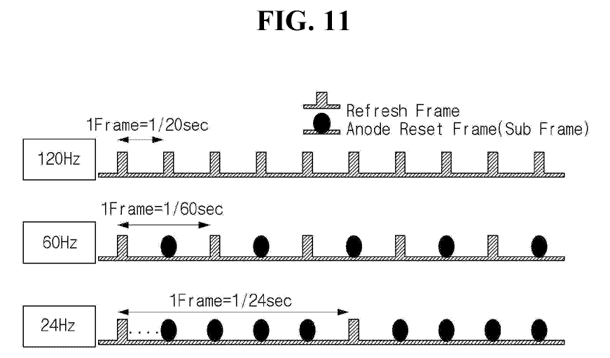

FIG. 8 is an example diagram illustrating a control transistor controlling an output of an anode initialization voltage and an element included in a subpixel of a display apparatus according to a second embodiment of the present disclosure, FIGS. 9 and 10 are example driving waveform diagrams of a display panel implemented based on the subpixel of FIG. 8, and FIG. 11 is a diagram for describing a driving characteristic of the display panel implemented based on the subpixel of FIG. 8.

As illustrated in FIG. 8, a subpixel P (e.g., each subpixel P of the display apparatus) can include a first transistor T1, a second transistor T2, a third transistor T3, a fourth transistor T4, a fifth transistor T5, a sixth transistor T6, a seventh transistor T7, a driving transistor DT, a capacitor CST, and a light emitting device OLED. In FIG. 8, an example can be described where the first transistor T1 and the fifth transistor T5 are implemented as an n type based on an oxide semiconductor, and the second transistor T2, the third transistor T3, the fourth transistor T4, the sixth transistor T6, the seventh transistor T7, and the driving transistor DT are implemented as a p type based on a polycrystalline semiconductor, but an embodiment of the present disclosure is not limited thereto.

The first transistor T1 can include a gate electrode connected to a first scan line SC1(n), a first electrode connected to a second node N2, and a second electrode connected to a third node N3. The first transistor T1 can be turned on in response to a first scan signal applied through the first scan line SC1(n). When the first transistor T1 is turned on, a threshold voltage of the driving transistor DT can be sampled. The first transistor T1 can be defined as a compensation transistor.

The second transistor T2 can include a gate electrode connected to a second scan line SC2(n), a first electrode connected to a data line DL, and a second electrode connected to a first node N1. The second transistor T2 can be turned on in response to a second scan signal applied through the second scan line SC2(n). When the second transistor T2 is turned on, a data voltage Vdata applied through the data line DL can be transferred to the first node N1. The second transistor T2 can be defined as a data supply transistor.

The third transistor T3 can include a gate electrode connected to an emission control signal line EM(n), a first electrode connected to a high-level voltage line EVDD, and a second electrode connected to the first node N1. The third transistor T3 can be turned on in response to an emission control signal applied through the emission control signal line EM(n). When the third transistor T3 is turned on, a high-level voltage applied through the high-level voltage line EVDD can be transferred to the first node N1. The third transistor T3 can be defined as an emission control transistor.

The fourth transistor T4 can include a gate electrode connected to the emission control signal line EM(n), a first electrode connected to the third node N3, and a second electrode connected to the anode electrode of the light emitting device OLED. The fourth transistor T4 can be turned on in response to the emission control signal applied through the emission control signal line EM(n). When the fourth transistor T4 is turned on, a driving current generated from the driving transistor DT can be transferred to the light emitting device OLED. When the fourth transistor T4 is turned on, the light emitting device OLED can emit light, based on the driving current generated from the driving transistor DT. The fourth transistor T4 can be defined as an emission control transistor.

The fifth transistor T5 can include a gate electrode connected to a fourth scan line SC4(n), a first electrode connected to a first initialization voltage line ViniL, and a second electrode connected to the second node N2. The fifth transistor T5 can be turned on in response to a fourth scan signal applied through the fourth scan line SC4(n). When the fifth transistor T5 is turned on, a first initialization voltage applied through the first initialization voltage line ViniL can be transferred to the second node N2. When the fifth transistor T5 is turned on, electric charges remaining in a gate electrode of the driving transistor DT connected to the second node N2 and a second electrode of the capacitor CST can be initialized. The fifth transistor T5 can be defined as an initialization transistor.

The sixth transistor T6 can include a gate electrode connected to a third scan line SC3(n), a first electrode connected to a second electrode of a control transistor TR_VAR connected to a second initialization voltage line VaraL, and a second electrode connected to the anode electrode of the light emitting device OLED. The sixth transistor T6 can be turned on in response to a third scan signal applied through the third scan line SC3(n). When the sixth transistor T6 is turned on, the second initialization voltage applied through the second initialization voltage line VaraL can be transferred to the anode electrode of the light emitting device OLED. When the sixth transistor T6 is turned on, an electric charge remaining in the anode electrode of the light emitting device OLED can be initialized. The sixth transistor T6 can be defined as an initialization transistor.

The seventh transistor T7 can include a gate electrode connected to the third scan line SC3(n), a first electrode connected to a bias voltage line VobsL, and a second electrode connected to the first node N1. The seventh transistor T7 can be turned on in response to the third scan signal applied through the third scan line SC3(n). When the seventh transistor T7 is turned on, a bias voltage applied through the bias voltage line VobsL can be transferred to the first node N1. When the seventh transistor T7 is turned on, the driving transistor DT connected to the first node N1 can maintain a stronger saturation state, based on the bias voltage. Accordingly, a phenomenon can be improved where a voltage charge time for charging of a voltage applied to the anode electrode of the light emitting device OLED during an emission period is reduced or delayed. The seventh transistor T7 can be defined as a bias transistor.

For example, as a level of the bias voltage Vobs increases, a voltage of the third node N3 which is a drain electrode of the driving transistor DT can increase, and a gate-source voltage or a drain-source voltage of the driving transistor DT can be reduced. Therefore, it can be preferable that a level of the bias voltage Vobs is at least higher than that of the data voltage Vdata. Under such a condition, a magnitude of a drain-source current Id passing through the driving transistor DT can decrease, and a stress of the driving transistor DT can be reduced, thereby preventing a charge delay of the third node N3. In other words, when an on bias stress operation is performed before sampling the threshold voltage of the driving transistor DT, a hysteresis of the driving transistor DT can be alleviated.

The driving transistor DT can include the gate electrode connected to the second node N2, a first electrode connected to the first node N1, and a second electrode connected to the third node N3. The driving transistor DT can be driven based on the data voltage Vdata stored in the capacitor CST to generate the driving current.

The capacitor CST can include a first electrode connected to the high-level voltage line EVDD and a second electrode connected to the second node N2. The capacitor CST can store the data voltage Vdata for a certain time, and then, can transfer the data voltage Vdata to the gate electrode of the driving transistor DT.

The light emitting device OLED can include the anode electrode connected to the second electrode of the fourth transistor T4 and a cathode electrode connected to the low-level voltage line EVSS. The light emitting device OLED can emit light, based on the driving current transferred through the turned-on fourth transistor T4.

According to the second embodiment, the control transistor TR_VAR can include a gate electrode connected to the third scan line SC3(n) to which the third scan signal is applied, a first electrode connected to the second initialization voltage line VaraL to which the second initialization voltage is applied, and a second electrode connected to the first electrode of the sixth transistor T6 included in the subpixel P.

A display panel implemented based on the subpixel P of FIG. 8 can be driven in a first driving mode, based on a driving waveform illustrated in FIG. 9, and moreover, can be driven in a second driving mode, based on a driving waveform illustrated in FIG. 10. The first driving mode can be included in a programming frame for high-speed driving of the display panel, and the second driving mode can be included in an anode reset frame for low-speed driving of the display panel.

As illustrated in FIGS. 9 and 10, a first scan signal Sc1(n), a second odd scan signal Sc2(n)_O, a second even scan signal Sc2(n)_E, a third scan signal Sc3(n), and a fourth scan signal Sc4(n) can be formed based on the gate high voltage Vgh and the gate low voltage Vgl, and a form of a pulse can be changed based on a driving mode. On the other hand, the emission control signal Em(n) can be formed based on the gate on voltage and the gate off voltage, and a form of a pulse may not be changed based on a driving mode. However, a driving waveform of FIGS. 9 and 10 can be merely an embodiment of the present disclosure, and the present disclosure is not limited thereto.

As illustrated in FIGS. 1 and 11, the display panel 100 can operate in a variable refresh rate (VRR) mode, based on the driving waveform described above. The VRR mode can be a driving mode where the display panel 150 is driven at a certain driving frequency, and then, increases or decreases a refresh rate needed for updating of a data voltage Vdata according to a high-speed driving or low-speed driving condition and reduces power consumption. For example, the display panel 100 can drive one frame at 120 Hz (1Frame = 1/120sec), or can drive one frame at 60 Hz (1Frame = 1/60sec), or can diversify a driving speed for driving one frame at 24 Hz (1Frame = 1/24sec).

Under a high-speed driving condition such as 120 Hz, a refresh frame for refreshing (image refresh) the data voltage Vdata at every frame can be provided. On the other hand, under a low-speed driving condition such as 60 Hz or 24 Hz, an anode reset frame for refreshing the data voltage Vdata at every N frames (where N can be an integer of 1 or more) can be provided between anode reset frames.

The anode reset frame can be included in a sub-frame, and a device can operate in a corresponding frame to enable the display panel 100 to normally display an image. Further, the anode reset frame can be performed under the low-speed driving condition. Therefore, the anode reset frame can correspond to a level where there is hardly a motion of an image, or a still image is displayed, and thus, can be defined as that only an output of a scan signal is performed in a state where an output of the data voltage Vdata stops, but embodiments of the present disclosure are not limited thereto.

Furthermore, according to the second embodiment, the control transistor TR_VAR of FIG. 8 can be turned off (TR_VAR OFF) based on the third scan signal of the gate high voltage Vgh applied through the third scan line SC3(n), so as to block a coupling effect between the second initialization voltage and a scan signal, and a configuration relevant thereto will be described below.

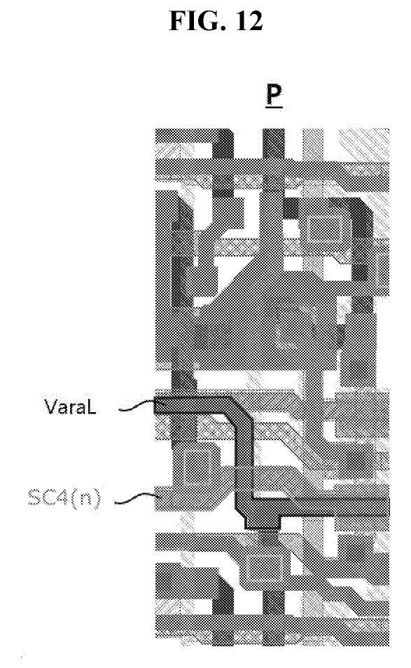

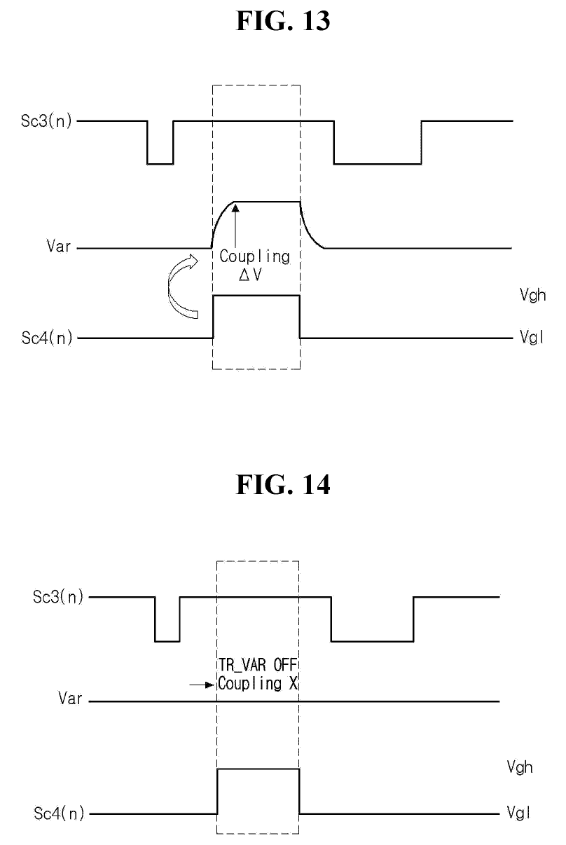

FIG. 12 is a diagram illustrating a portion of a subpixel implemented based on FIG. 8, FIG. 13 is a diagram for describing a comparative example including no control transistor, and FIG. 14 is a diagram for describing the second embodiment including the control transistor.

As illustrated in FIG. 12, a portion of a second initialization voltage line VaraL transferring a second initialization voltage to a subpixel P can overlap a portion of a fourth scan line SC4(n) transferring a fourth scan signal. As described above, when the second initialization voltage line VaraL and the fourth scan line SC4(n) disposed in different layers overlap each other, a parasitic capacitor can be formed.

In a case where a structure illustrated in FIG. 12 is provided, the comparative example does not include a control transistor, as in FIG. 13, a second initialization voltage Var and a fourth scan signal Sc4(n) can be put in a coupling state whenever the fourth scan signal Sc4(n) of a gate high voltage Vgh is applied. Accordingly, the second initialization voltage Var can be put in the coupling state affected by the fourth scan signal Sc4(n) of a gate high voltage Vgh, and thus, can increase (see ΔV of FIG. 6).

In a case where the structure illustrated in FIG. 12 is provided, the second embodiment can include a control transistor, as in FIG. 14, the control transistor can be put in a turn-off state (TR_VAR OFF) whenever the fourth scan signal Sc4(n) of the gate high voltage Vgh is applied, and thus, the second initialization voltage Var and the fourth scan signal Sc4(n) can be put in a decoupling state which is not affected by the coupling effect. Accordingly, the second initialization voltage Var can be put in the decoupling state affected by the fourth scan signal Sc4(n) of the gate high voltage Vgh, and thus, may not increase.

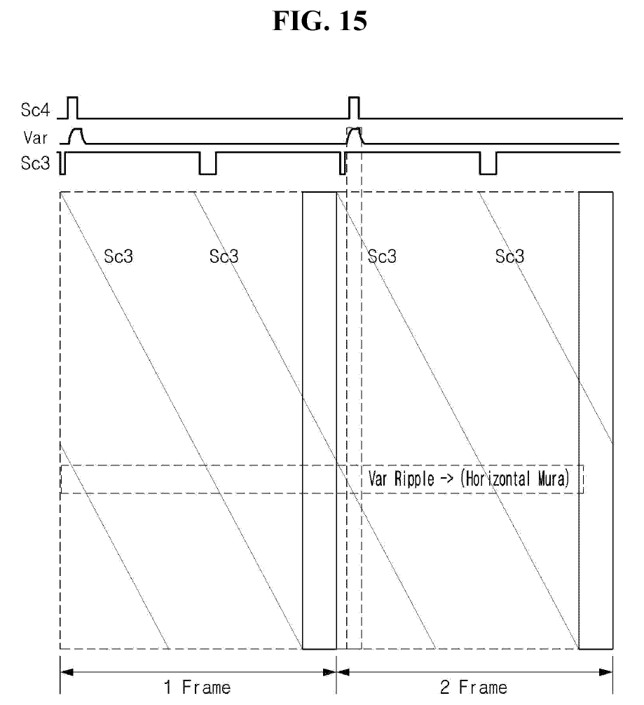

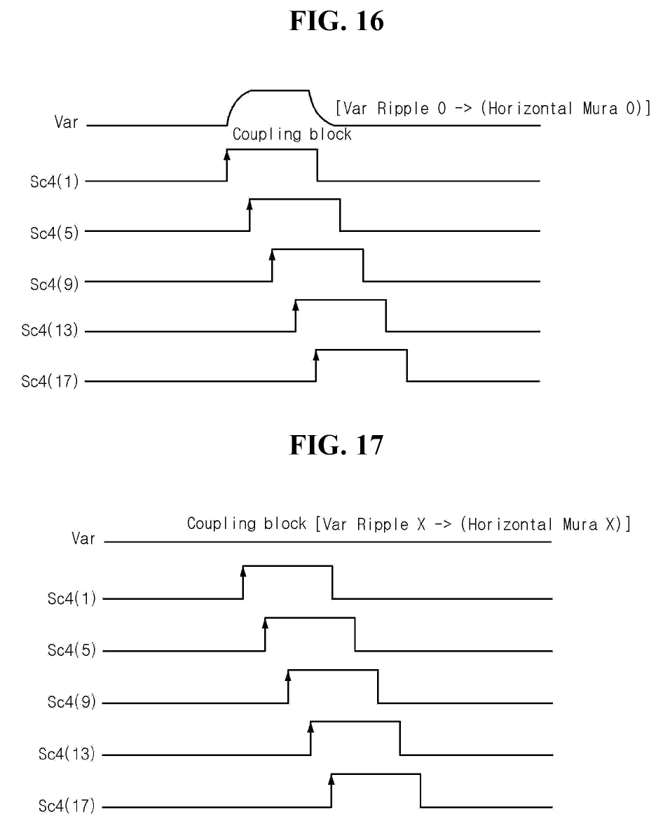

FIG. 15 is a diagram for describing a problem occurring when a second initialization voltage increases, in a comparative example including no control transistor, FIG. 16 is a diagram for describing the comparative example including no control transistor, and FIG. 17 is a diagram for describing the second embodiment including the control transistor.

As illustrated in FIG. 15, in a comparative example including no control transistor, a voltage ripple (Var Ripple) where a second initialization voltage Var increases can occur whenever a fourth scan signal Sc4 of a gate high voltage is applied. The voltage ripple (Var Ripple) can cause horizontal mura which affects the image quality of a horizontal line.

The voltage ripple (Var Ripple) shown in FIG. 15 may not appear in one horizontal line direction and can continuously appear in horizontal lines to which the fourth scan signal Sc4 of the gate high voltage is applied. This can be seen with reference to a fourth scan signal Sc4(1) of a first horizontal line illustrated in FIG. 16, a fourth scan signal Sc4(5) of a fifth horizontal line, and a fourth scan signal Sc4(9) of a ninth horizontal line.

Therefore, the voltage ripple (Var Ripple) shown in the comparative example can continuously appear in horizontal lines to which the fourth scan signal Sc4 of the gate high voltage is applied, and due to this, horizontal mura affecting the image quality of a horizontal line can occur (see "Var Ripple O -> Horizontal Mura O" of FIG. 16).

On the other hand, the second embodiment can block a coupling effect where the second initialization voltage Var increases whenever the fourth scan signal Sc4 is applied, based on the control transistor, and thus, can prevent the occurrence of the voltage ripple (Var Ripple) and horizontal mura caused thereby (see "Var Ripple X -> Horizontal Mura X" of FIG. 17). Accordingly, the control transistor can be disposed for each horizontal line so as to prevent the occurrence of horizontal mura.

Furthermore, a period where the second initialization voltage Var is applied can be defined as an initialization period. Accordingly, it can be described that the control transistor has a turn-off state at every one initialization period where the second initialization voltage Var is applied.

Hereinafter, in describing a third embodiment of the present disclosure, a configuration which differs from the second embodiment will be mainly described. Therefore, a configuration which is not described with reference to FIG. 3 can refer to the description of the second embodiment.

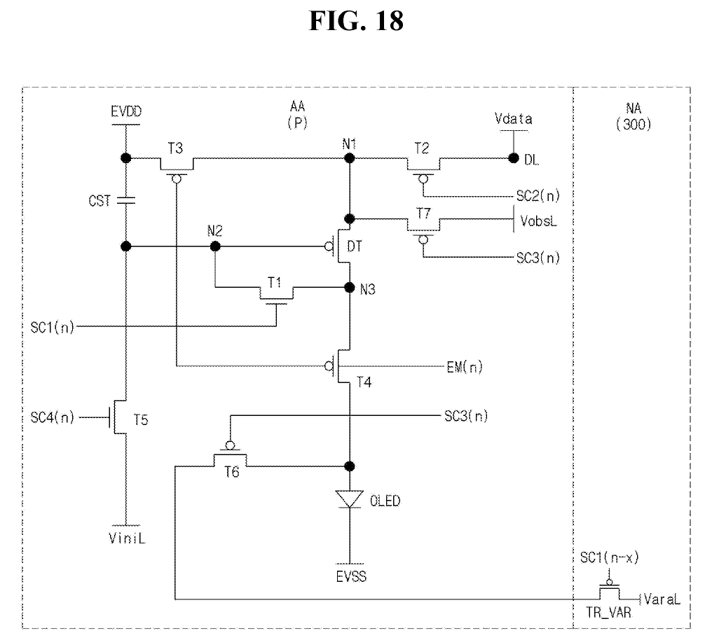

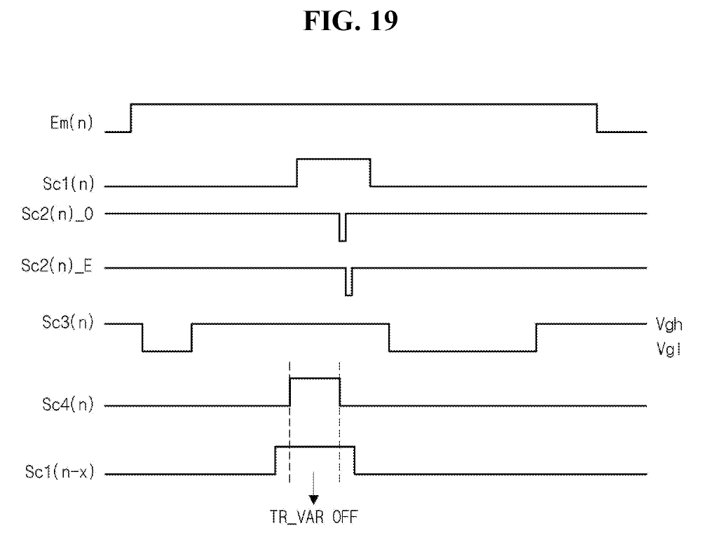

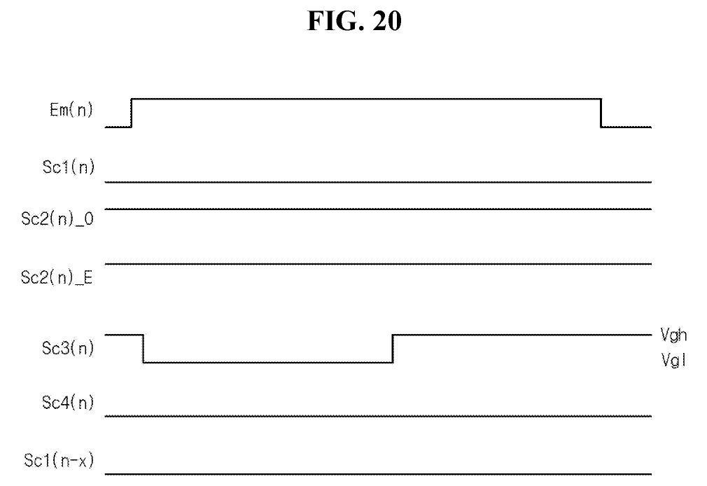

FIG. 18 is an example diagram illustrating a control transistor controlling an output of an anode initialization voltage and an element included in a subpixel of a display apparatus according to a third embodiment of the present disclosure, and FIGS. 19 and 20 are example driving waveform diagrams of a display panel implemented based on the subpixel of FIG. 18.

According to the third embodiment, a control transistor TR_VAR can include a gate electrode connected to an N-1^{st} scan line SC1(n-x) to which an N-1^{st} scan signal is applied, a first electrode connected to a second initialization voltage line VaraL to which a second initialization voltage is applied, and a second electrode connected to a first electrode of a sixth transistor T6 included in a subpixel P. This configuration can be applied to each subpixel P of the display panel/apparatus.

The display panel implemented based on the subpixel P of FIG. 18 can be driven in a first driving mode, based on a driving waveform illustrated in FIG. 19, and moreover, can be driven in a second driving mode, based on a driving waveform illustrated in FIG. 20.

As illustrated in FIGS. 19 and 20, an emission control signal Em(n), a first scan signal Sc1(n), a second odd scan signal Sc2(n)_O, a second even scan signal Sc2(n)_E, a third scan signal Sc3(n), and a fourth scan signal Sc4(n) can be formed based on a gate high voltage Vgh and a gate low voltage Vgl and can be changed based on a driving mode.

As illustrated in FIGS. 18 and 19, a control transistor TR_VAR can have a turn-off (TR_VAR OFF) state during a period where a fourth scan signal Sc4(n) of a gate high voltage Vgh is applied, based on an N-1^{st} scan signal Sc1(n-x). The N-1^{st} scan signal Sc1(n-x) can correspond to a first scan signal of a front-end horizontal line which is generated to have a gate high voltage prior to a first scan signal Sc1(n).

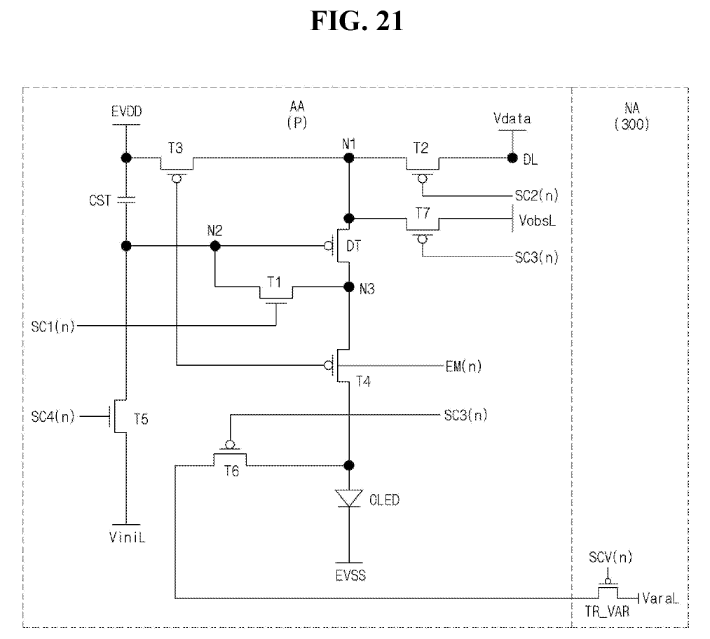

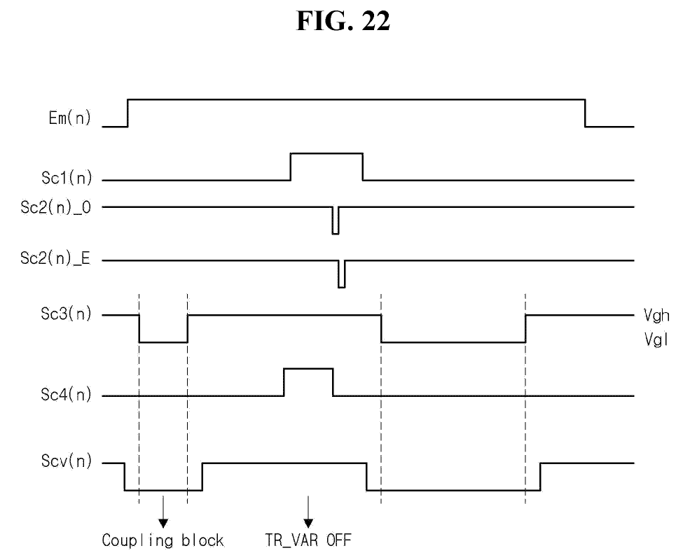

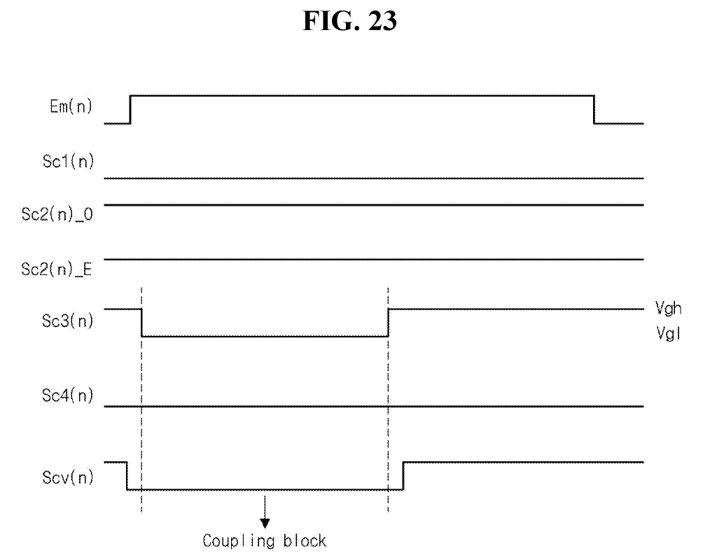

FIG. 21 is an example diagram illustrating a control transistor controlling an output of an anode initialization voltage and an element included in a subpixel of a display apparatus according to a fourth embodiment of the present disclosure, and FIGS. 22 and 23 are example driving waveform diagrams of a display panel implemented based on the subpixel of FIG. 21.

According to the fourth embodiment, a control transistor TR_VAR can include a gate electrode connected to a control scan line SCV(n) to which a separate control scan signal Scv(n) is applied, a first electrode connected to a second initialization voltage line VaraL to which a second initialization voltage is applied, and a second electrode connected to a first electrode of a sixth transistor T6 included in a subpixel P. This configuration can be applied to each subpixel P of the display panel/apparatus.

The display panel implemented based on the subpixel P of FIG. 21 can be driven in a first driving mode, based on a driving waveform illustrated in FIG. 22, and moreover, can be driven in a second driving mode, based on a driving waveform illustrated in FIG. 23.

As illustrated in FIGS. 22 and 23, an emission control signal Em(n), a first scan signal Sc1(n), a second odd scan signal Sc2(n)_O, a second even scan signal Sc2(n)_E, a third scan signal Sc3(n), and a fourth scan signal Sc4(n) can be formed based on a gate high voltage Vgh and a gate low voltage Vgl and can be changed based on a driving mode.

As illustrated in FIGS. 21 to 23, a control transistor TR_VAR can have a turn-off (TR_VAR OFF) state during a period where a fourth scan signal Sc4(n) of a gate high voltage Vgh is applied, based on a separate control scan signal Scv(n). Further, the control scan signal Scv(n) can be generated to block a coupling effect with a third scan signal Sc3(n) of a gate low voltage Vgl. For example, the control scan signal Scv(n) can be generated to have the gate low voltage Vgl at a time equal or similar to the third scan signal Sc3(n).

In FIG. 22, an example is illustrated where the control scan signal Scv(n) is first generated to have the gate high voltage Vgh, the fourth scan signal Sc4(n) is generated to have the gate high voltage Vgh subsequently, the fourth scan signal Sc4(n) is shifted to the gate low voltage Vgl subsequently, and the control scan signal Scv(n) is shifted to the gate low voltage Vgl subsequently, but the present disclosure is not limited thereto. For example, a generation time and an end time of the gate high voltage Vgh of the control scan signal Scv(n) can be synchronized with a generation time and an end time of the gate high voltage Vgh of the fourth scan signal Sc4(n).

In FIGS. 22 and 23, an example is illustrated where a generation time and an end time of the gate low voltage Vgl of the control scan signal Scv(n) differ from a generation time and an end time of the gate low voltage Vgl of the third scan signal Sc3(n), but the present disclosure is not limited thereto. For example, the generation time and the end time of the gate low voltage Vgl of the control scan signal Scv(n) can be synchronized with the generation time and the end time of the gate low voltage Vgl of the third scan signal Sc3(n).

Hereinabove, the present disclosure provides a display apparatus which can block or minimize a coupling effect between an initialization voltage applied through an anode electrode of a light emitting device and a scan signal applied adjacent thereto to prevent the occurrence of a voltage ripple and can stably apply the initialization voltage. Further, the present disclosure provides a display apparatus which can allow the initialization voltage to be stably applied and can thus prevent the occurrence of horizontal mura (an image quality defect of a horizontal line), thereby enhancing display quality.

The effects according to the present disclosure are not limited to the above examples, and other various effects can be included in the disclosure.

While the present disclosure has been particularly shown and described with reference to example embodiments thereof, it will be understood by those of ordinary skill in the art that various changes in form and details can be made therein without departing from the spirit and scope of the present disclosure as defined by the following claims.

What is claimed is:

1. A display apparatus comprising:
a display panel including a subpixel;
a scan driver including at least one scan line configured to apply at least one scan signal to the display panel;
a data driver configured to apply a data voltage to the display panel;
an initialization voltage line connected to the subpixel ; and
a control transistor configured to control whether to apply an initialization voltage through the initialization voltage line.

2. The display apparatus of claim 1, wherein, when the at least one scan signal is applied as a voltage for turning on a transistor, the control transistor is turned off to cut off supply of the initialization voltage.

3. The display apparatus of claim 2, wherein the initialization voltage line comprises a region disposed to overlap the at least one scan line.

4. The display apparatus of claim 1, wherein the control transistor is disposed in a non-display area of the display panel, the non-display area configured to not display an image.

5. The display apparatus of claim 1, wherein the subpixel comprises a p-type transistor and an n-type transistor,
the at least one scan line comprises an A^{th} scan line for controlling the p-type transistor and a B^{th} scan line for controlling the n-type transistor, and
the control transistor is turned on or off based on the B^{th} scan signal applied through the B^{th} scan line.

6. The display apparatus of claim 1, wherein the subpixel comprises first to seventh transistors,
the at least one scan line comprises a first scan line for controlling the first transistor, a second scan line for controlling the second transistor, a third scan line for controlling the sixth transistor and the seventh transistor, and a fourth scan line for controlling the fifth transistor, and
the control transistor is turned on or off based on a third scan signal applied through the third scan line.

7. The display apparatus of claim 6, wherein the initialization voltage line comprises a region disposed to overlap the fourth scan line.

8. The display apparatus of claim 7, wherein, when a fourth scan signal of a gate high voltage is applied through the fourth scan line, the control transistor is turned off to cut off supply of the initialization voltage.

9. A driving method of a display apparatus, the driving method comprising:
applying a scan signal through at least one scan line connected to a display panel;
applying a data voltage through a data line connected to the display panel; and
applying an initialization voltage through an initialization voltage line connected to a subpixel of the display panel,
wherein the applying of the initialization voltage comprises cutting off supply of the initialization voltage when the scan signal is applied as a voltage for turning on a transistor included in the display panel.

10. The driving method of claim 9, wherein the initialization voltage line comprises a region disposed to overlap the at least one scan line.
